(19) United States
(12) Patent Application Publication
(10) Pub. No.: US 2025/0085390 A1
(43) Pub. Date: Mar. 13, 2025

(54) SURROUNDINGS MONITORING APPARATUS AND PROGRAM PRODUCT

(71) Applicants: DENSO CORPORATION, Kariya-city (JP); TOYOTA JIDOSHA KABUSHIKI KAISHA, Toyota-shi (JP)

(72) Inventors: Junzoh TSUCHIYA, Tokyo (JP); Naotsugu SHIMIZU, Tokyo (JP); Masafumi IBUSHI, Tokyo (JP); Seiya FUJITSU, Tokyo (JP); Keita SUGIURA, Tokyo (JP); Koji TAKEUCHI, Toyota-shi (JP); Takaya YAMASHITA, Nagoya-shi (JP); Hiroki SHIMAZU, Nisshin-shi (JP); Junya FUKUTA, Nagoya-shi (JP)

(21) Appl. No.: 18/957,084

(22) Filed: Nov. 22, 2024

Related U.S. Application Data
(63) Continuation of application No. PCT/JP2023/016359, filed on Apr. 25, 2023.

(30) Foreign Application Priority Data
May 25, 2022 (JP) 2022-085539

(51) Int. Cl. G01S 7/41; G01S 13/931

(52) U.S. Cl. CPC G01S 7/41; G01S 13/931; G01S 2013/9315

(57) ABSTRACT

In a surroundings monitoring apparatus, a third determiner determines, based on a positional relationship between the object determined by a first determiner and the towed vehicle determined by a second determiner, whether the rearward side object is a ghost. An establishing unit establishes an object searching area located at least in front of or on the right or left side of an own vehicle in accordance with:
(i) a position of a radio-wave transceiver;
(ii) at least one of a position of each of left and right edges of the front end of the towed vehicle and a position of each of left and right edges of the rear end of the towed vehicle; and
(iii) an angle of the towed vehicle tilted to a traveling direction of the own vehicle.

The first determiner determines whether an object is located in the established searching area.

### CROSS REFERENCE TO RELATED APPLICATION

This application is a bypass continuation application of currently pending international application No. PCT/JP2023/016359 filed on Apr. 25, 2023 designating the United States of America, the entire disclosure of which is incorporated herein by reference, the international application being based on and claiming the benefit of priority from Japanese Patent Application No. 2022-085539 filed on May 25, 2022, the disclosure of which is incorporated in its entirety herein by reference.

### TECHNICAL FIELD

The present disclosure relates to surroundings monitoring apparatuses and program products.

### BACKGROUND

There are known disclosures, which acquire information around an own vehicle, and support a driver of the own vehicle in accordance with the acquired information. For example, one of the disclosures, which is U.S. Pat. No. 9,211,889, recognizes an object located behind an own vehicle using, for example, an ultrasonic sensor, a radar device, and/or a camera, and supports a driver of the own vehicle in accordance with the recognition results.

### SUMMARY

Radar devices acquire information on an object based on radar waves reflected from the object. If an object is located behind an own vehicle, such as a towed vehicle coupled the own vehicle, radar waves multiply reflected by the object and one or more other objects located in front of the object may cause ghosts. If an apparatus disclosed in the patent publication detects such ghosts within a predetermined support region for the driver, the apparatus may perform supporting operations for the driver based on the detected ghosts. This is because the apparatus fails to have a function of determining whether detected objects are ghosts.

Because the supporting operations for the driver based on the detected ghosts are undesirable, development of a technology, which determines whether a detected object is a ghost and excludes the detected object from a recognition target, is desired.

From this viewpoint, the present disclosure seeks to provide surroundings monitoring apparatuses and program products, each of which is capable of properly recognizing objects located behind an own vehicle while excluding ghosts from a recognition target.

The present disclosure provides a surroundings monitoring apparatus for recognizing, based on detection information acquired from a radio-wave transceiver, a rearward side object located behind and to a right or left side of an own vehicle, the radio-wave transceiver having a detection range located behind and to the right or left side of the own vehicle. The surroundings monitoring apparatus includes a first determiner configured to determine whether an object is located at least in front of or on a right or left side of the own vehicle, and a second determiner configured to determine whether a towed vehicle is located behind the own vehicle, the towed vehicle being coupled with the own vehicle, the towed vehicle having a front end and a rear end. The surroundings monitoring apparatus includes a third determiner configured to, in response to determination that (i) the object is located at least in front of or on the right or left side of the own vehicle and (ii) the towed vehicle is located behind the own vehicle, determine, based on a positional relationship between the object determined by the first determiner and the towed vehicle determined by the second determiner, whether the rearward side object is a ghost due to the object determined by the first determiner and the towed vehicle determined by the second determiner.

In a case where an object is located at least in front of or on the right or left side of the own vehicle, and a rearward object is located behind the own vehicle, a positional relationship between the object located at least in front of or on the right or left side of the own vehicle and the rearward object may cause multiple reflection of radio waves between the object located at least in front of or on the right or left side of the own vehicle and the rearward object. In this case, a recognized rearward side object may be a ghost due to the object located at least in front of or on the right or left side of the own vehicle and the rearward object.

From this viewpoint, the first determiner is configured to determine whether an object is located at least in front of or on the right or left side of the own vehicle, and the second determiner is configured to determine whether a rearward object is located behind the own vehicle.

In response to determination that the object is located at least in front of or on the right or left side of the own vehicle, and the rearward object is located behind the own vehicle, it is possible to recognize that radio-wave multiple reflection is likely to occur between the object located at least in front of or on the right or left side of the own vehicle and the rearward object.

Then, the third determiner is configured to determine, based on the positional relationship between the object located at least in front of or on the right or left side of the own vehicle and the rearward object, whether the rearward side object is a ghost due to the object located at least in front of or on the right or left side of the own vehicle and the rearward object.

This configuration therefore makes it possible to exclude the recognized rearward side object, which is determined to be a ghost, from a recognition target, thus reliably recognizing actual objects located behind the own vehicle.

### BRIEF DESCRIPTION OF THE DRAWINGS

Other aspects of the present disclosure will become apparent from the following description of embodiments with reference to the accompanying drawings in which:

FIG. 1 is a block diagram of a surroundings monitoring system according to the first embodiment;

FIG. 2 is a view schematically illustrating an example of a detection area of each radar device;

FIG. 3A is a view schematically illustrating an example of establishing warning areas for an own vehicle that is an ordinary vehicle itself;

FIG. 3B is a view schematically illustrating an example of establishing warning areas for the own vehicle with a towed vehicle coupled with the own vehicle;

FIG. 4 is a view schematically illustrating a searching area;

FIGS. 5A and 5B are views schematically illustrating an example of how to establish the searching area;

FIG. 6 is a view schematically illustrating an example of how to calculate a position at which a ghost may occur;

FIG. 7 is a view schematically illustrating an example of how to establish a ghost determination area;

FIG. 8 is a flowchart schematically illustrating an exemplary routine carried out by a surroundings monitoring apparatus of the first embodiment;

FIG. 9 is a block diagram of a surroundings monitoring system according to the second embodiment;

FIG. 10 is a view schematically illustrating an example of how to establish a hard-to-detect area;

FIG. 11 is a flowchart schematically illustrating an exemplary routine carried out by a surroundings monitoring apparatus of the second embodiment;

FIG. 12 is a view schematically illustrating a task of continuing a determination that a rearward side object is a ghost; and

FIG. 13 is a flowchart schematically illustrating an exemplary routine carried out by a surroundings monitoring apparatus of a typical modification of the first and second embodiments.

### DETAILED DESCRIPTION OF EMBODIMENT

The following describes exemplary embodiments of the present disclosure with reference to the accompanying drawings.

### First Embodiment

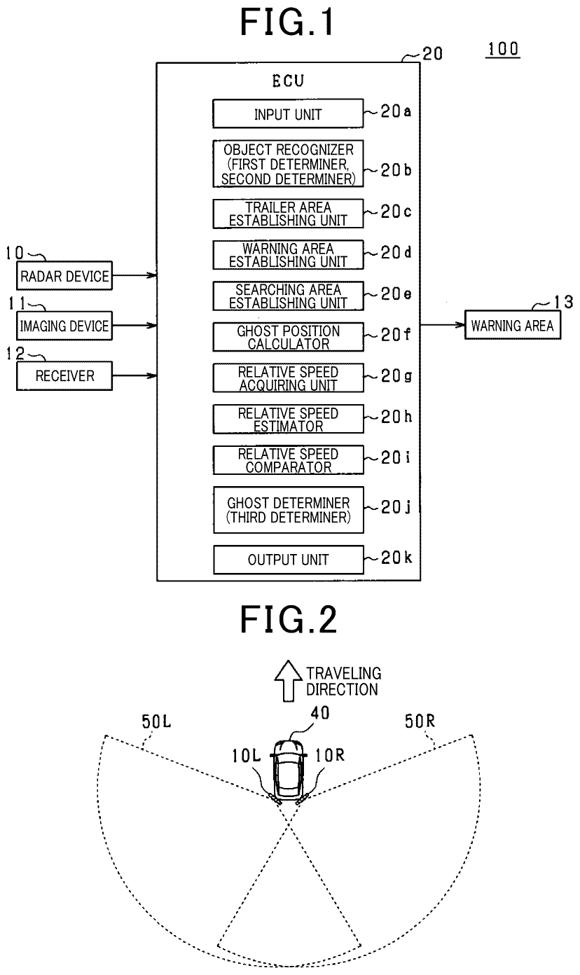

The following describes a configuration example of a surroundings monitoring system 100 according to the first embodiment with reference to FIG. 1.

Referring to FIG. 1, the surroundings monitoring system 100 installed in an own vehicle 40 includes one or more radar devices 10, an imaging device 11, a receiver 12, a warning device 13, and an electronic control unit (ECU) 20. The ECU 20 serves as a surroundings monitoring apparatus, i.e., a control apparatus.

Each radar device 10 is a known millimeter-wave radar for emitting, as probing waves, high-frequency signals win a predetermined millimeter-wave range. Each of the radar devices 10 can be freely mounted to any location of the own vehicle 40. As one example, the surroundings monitoring system 100 includes two radar devices 10L and 10R as the one or more radar devices 10. The radar device 10L is mounted to a left side of the rear end of the own vehicle 40, and the radar device 10R is mounted to a right side of the rear end of the own vehicle 40.

The radar device 10L has a detection area 50L (see FIG. 2) and is capable of detecting one or more objects located within the detection area 50L. The radar device 10R has a detection area 50R (see FIG. 2) and is capable of detecting one or more objects located within the detection area 50R. Specifically, the radar device 10L detects objects located within the detection area 50L ranging from the rear of the own vehicle 40 to the left-side of the own vehicle V, and the radar device 10R detects objects located within the detection area 50R ranging from the rear of the own vehicle 40 to the right-side of the own vehicle V.

Each of the radar devices 10L and 10R, which has one or more antennas, is configured to transmit a probing wave every predetermined period to the corresponding detection area, and receive, through the corresponding one or more antennas, reflection waves from one or more objects located within the corresponding detection area as detection information. Then, each of the radar devices 10L and 10R is configured to output, to the ECU 20, the corresponding detection information.

For example, the ECU 20 can calculate a difference between a transmission time of each probing wave and receiving times of one or more reflection waves resulting from reflection of the corresponding probing wave by an object to accordingly calculate a distance between the own vehicle 40 and the object. The ECU 20 can calculate a relative speed of the object relative to the own vehicle 40 in accordance with frequencies of the one or more reflection waves, which have been changed based on the Doppler effect. Additionally, the ECU 20 can calculate phase differences among the reflection waves received by the antennas to accordingly calculate an azimuth of the object. Calculation of the distance and the azimuth of the object enables a relative location of the object relative to the own vehicle 40 to be identified. Each of the radar devices 10 serves as a radio-wave transceiver. Other devices, each of which results in reflection of transmitted radio waves by the outer surface of any object, can be used as the radio-wave transceiver.

The imaging device 11 is comprised of a camera equipped with, for example, a charge-coupled device (CCD), a complementary metal oxide semiconductor device (CMOS), or another imaging device. The imaging device can be configured as a monocular camera or a stereo camera. The surroundings monitoring system 100 can include a single imaging device 11 or plural imaging devices 11. The single imaging device 11 or one of the plural imaging devices 11 can be mounted to, for example, a predetermined portion of the body of the own vehicle 40; the portion of the body of the own vehicle 40 has a predetermined height and is centrally located in the width direction of the own vehicle 40. The imaging device 11 mounted to the predetermined portion of the body of the own vehicle has a predetermined angular field in front of or in rear of the own vehicle 40, and is configured to successively produce a bird's-eye image of the predetermined angular field, and successively output the captured images to the ECU 20.

The receiver 12 is configured to receive global-positioning signals from a global positioning system (GPS), such as a GPS receiver. Specifically, the receiver 12 is configured to receive the global-positioning signals indicative of the current location of the own vehicle 40, and output the received global-positioning signals to the ECU 20.

The warning device 13 is configured to issue information to, for example, the driver of the own vehicle 40. For example, the warning device 13 includes a visible issuing device for issuing visible information, such as a display device, installed in the own vehicle 40, and/or an audible issuing device for issuing audible information, such as a speaker and/or a buzzer, installed in the own vehicle 40. Another device can be freely used as the warning device 13.

The warning device 13 is configured to issue warning information, such as warning sound, in response to receiving a control instruction sent from the ECU 20 to accordingly inform the driver of a collision risk of the own vehicle 40 with one or more objects.

The ECU 20 is, for example, a known microcomputer that includes, for example, at least one central processing unit (CPU), at least one memory device, and one or more input-output (I/O) unit. The ECU 20a includes an input unit 20a and an output unit 20k. The input and output units 20a and 20k serve as an I/O interface that enables the ECU 20 to communicate various data items with the radar devices 10, the imaging device 11, the receiver 12, and the warning device 13. The ECU 20 serves as an information processing apparatus that operates based on information items acquired from the radar devices 10, the imaging device 11, and the receiver 12. Functions provided from the ECU 20 can be implemented by the combination of software stored in a non-transitory storage medium and a computer that executes the software. Alternatively, the functions provided from the ECU 20 can be implemented by only software, only hardware, or the combination of software and hardware.

The ECU 20 includes, as information-processing functions, an object recognizer 20b, a trailer area establishing unit 20c, a warning area establishing unit 20d, and a searching area establishing unit 20e. Additionally, the ECU 20 functionally includes, as information-processing functions, a ghost position calculator 20f, a relative speed acquiring unit 20g, a relative speed estimator 20h, a relative speed comparator 20i, and a ghost determiner 20j. The details of these functional units will be described later.

The ECU 20 according to the first embodiment has a so-called “blind-spot monitoring function”. The blind-spot monitoring function is a function of supporting collision avoidance of the own vehicle 40 with one or more other vehicles located in a blind-spot area located behind and to the left- and right-side of the own vehicle 40; the blind-spot area is likely to become a blind spot for the driver of the own vehicle 40 so as to be difficult to visibly recognize.

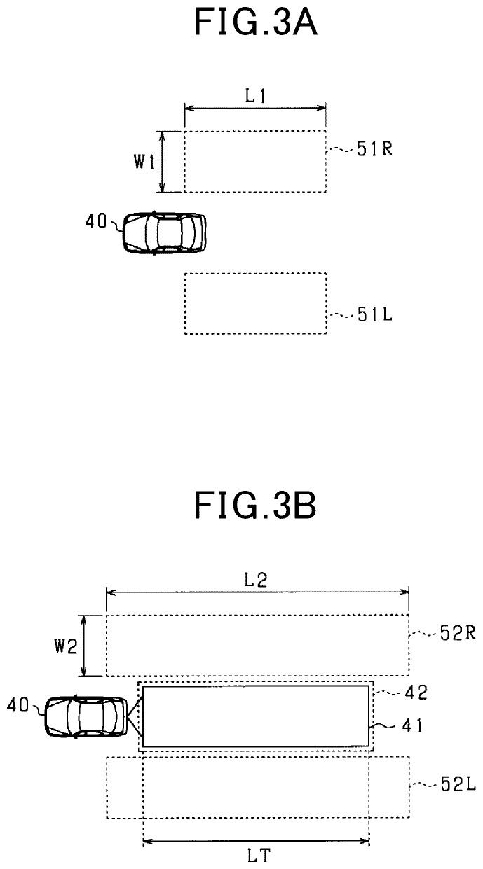

Next, the following describes the warning areas established by the warning area establishing unit 20d with reference to FIGS. 3A and 3B. Each of the warning areas according to the first embodiment is defined as an area where, when an object is detected by one of the radar devices 10 in the area, one or more collision inhibition operations are carried out, which inhibit a collision of the own vehicle 40 with the detected object. For example, the warning device 13 carries out the one or more collision inhibition operations in response to a corresponding control instruction outputted from the output unit 20k.

The one or more collision inhibition operations include, for example, an operation of issuing a warning to the driver of the own vehicle 40. For example, the warning device 13 causes at least one LED indicator mounted to, for example, at least one door mirror of the own vehicle 40 to be turned on, thus issuing a warning to the driver of the own vehicle 40. Such a function of the ECU 20, which instructs the warning device 13 to issue a warning to the driver of the own vehicle 40, is included in the blind-spot monitoring function. Objects, which are targets for the one or more collision inhibition operations may include, for example, other vehicles including buses and trucks, motor bicycles, bicycles, pedestrians, and other objects located in the blind-spot area.

As illustrated in FIG. 3A, the warning area establishing unit 20d is configured to establish a warning area, i.e., a normal warning area, 51R located behind and to the right of the own vehicle 40, and a warning area, i.e., a normal warning area, 51L located behind and to the left of the own vehicle 40. In particular, the warning area establishing unit 20d establishes the warning area 51R overlapping the detection area 50R (see FIG. 2), and establishes the warning area 51L overlapping the detection area 50L (see FIG. 2). The whole of each of the warning areas 51R and 51L can overlap the corresponding one of the detection areas 50R and 50L or each of the warning areas 51R and 51L can partly overlap the corresponding one of the detection areas 50R and 50L.

The established warning area 51R is, as illustrated in FIG. 3A, located on the right side of the own vehicle 40 to include a part of the rear end of the own vehicle 40 and an area located behind the own vehicle 40. The established warning area 51L is, as illustrated in FIG. 3A, located on the left side of the own vehicle 40 to include a part of the rear end of the own vehicle 40 and an area located behind the own vehicle 40.

Each of the warning areas 51R and 51L has a substantially rectangular shape having a length L1 in the longitudinal direction of the own vehicle 40 and a width W1 in the width direction of the own vehicle 40. The length L1 is, for example, set to be within 5 to 10 m, and the width is, for example, set to the width of an adjacent lane in the width direction of the own vehicle 40; the adjacent lane is located adjacently to the traveling lane in which the own vehicle 40 is traveling. The shape and size of the right-side warning area 51R are respectively identical to those of the left-side warning area 51L, but at least one of the shape and size of the right-side warning area 51R can be different from the corresponding at least one of the shape and size of the left-side warning area 51L. The warning area 51R can be defined as a region that is located on the right side of the own vehicle 40 and extends from the rear end of the own vehicle 40 toward the rear of the own vehicle 40. Similarly, the warning area 51L can be defined as a region that is located on the left side of the own vehicle 40 and extends from the rear end of the own vehicle 40 toward the rear of the own vehicle 40.

FIG. 3A illustrates an example of warning areas established for the own vehicle 40 that is an ordinary vehicle itself.

The own vehicle 40 may travel with another vehicle towed behind the own vehicle 40.

The following describes how the warning area establishing unit 20d establishes warning areas for the own vehicle 40 that is towing another vehicle, which will be referred to as a towed vehicle, therebehind with reference to FIG. 3B.

The first embodiment assumes that the own vehicle 40 is traveling while towing a trailer 41, which is an example of a towed vehicle, coupled to the rear portion of the own vehicle 40. FIG. 3B illustrates how the trailer 41 is towed by the own vehicle 40.

If the trailer 41 is coupled to the rear portion of the own vehicle 40, the warning area establishing unit 20d is configured to establish, as illustrated in FIG. 3B, a right-side warning area 52R whose length L2 extends backward to be longer than the length of the right-side warning area 51R. Similarly, the warning area establishing unit 20d is configured to establish, as illustrated in FIG. 3B, a left-side warning area 52L whose length L2 extends backward to be longer than the length of the left-side warning area 51L.

Specifically, the warning area establishing unit 20d is configured to establish each of the right- and left-side warning areas 52R and 52L, each of the right- and left-side warning areas 52R and 52L extends backward to be longer by a length LT of the trailer 41 than the length of the corresponding one of the right- and left-side warning areas 51R and 51L. The length of the trailer 41 is an item of trailer information; the trailer information will be described later.

Each of the warning areas 52R and 52L, which extends backward to be longer than the corresponding one of the warning areas 51R and 51L, has a substantially rectangular shape having the length L2 in the longitudinal direction of the own vehicle 40 and a width W2 in the width direction of the own vehicle 40. The length L2 of each of the warning areas 52R and 52L is determined to cause the rear end of the corresponding one of the warning areas 52R and 52L to be located behind the rear end of the trailer 41. The width W2 of each of the warning areas 52R and 52L is determined to be equal to the width W1 of the corresponding one of the warning areas 51R and 51L, which is expressed by W1=W2. The first embodiment describes the trailer 41 that is a V-type trailer, but a round-type trailer, a box-type trailer, a boat-type trailer, or a dolly-type trailer can be used as the trailer 41.

Reference character 42 represents a trailer area that is defined as an area that surrounds the trailer 41 and has a size slightly greater than the planar size of the trailer 41. The trailer area 42 is not limited to the above definition. Specifically, the trailer area 42 can be overlapped with the planar region of the trailer 41.

The trailer area establishing unit 20c is configured to acquire trailer information on the shape of the trailer 41, and establish the trailer area 42 based on the acquired trailer information. The shape of the trailer 41 is defined as a shape of the trailer 41 when viewed from above. The trailer information can be inputted to the ECU 20 by the driver of the own vehicle 40 or can be sent to the ECU 20 from the trailer 41. The trailer area establishing unit 20c can be configured to analyze data acquired by at least one of the radar devices 10 and the imaging device 11 to accordingly acquire the trailer information.

As described above, radar waves emitted from the radar devices 10 and multiply reflected by the trailer 41 and one or more other objects located around the own vehicle 40 may cause ghosts.

From this viewpoint, the searching area establishing unit 20e is configured to establish a searching area for searching for one or more objects that are located around the own vehicle 40 and are likely to become a factor for ghosts.

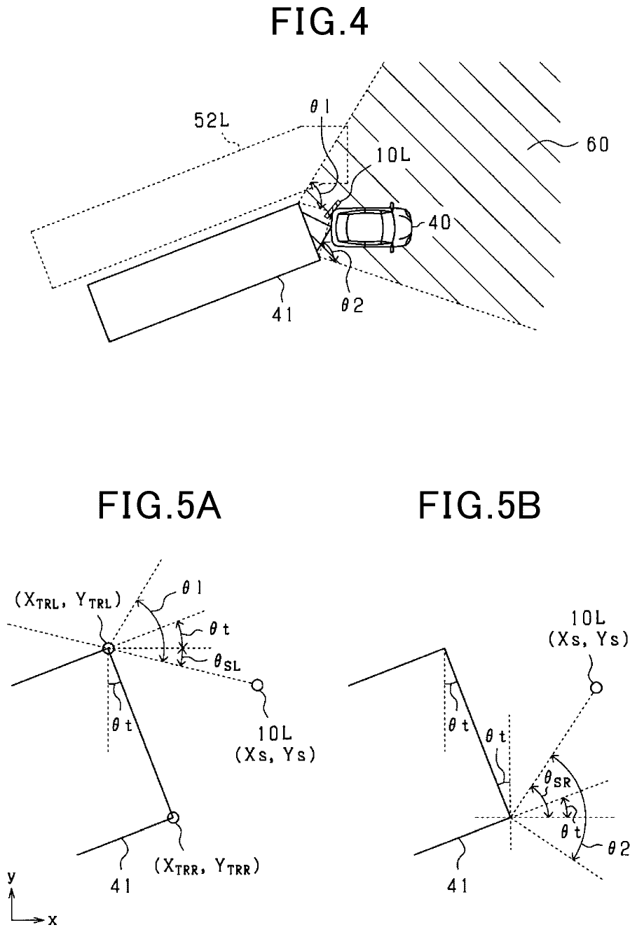

The following describes the searching area with reference to FIG. 4.

The searching area is an area for searching for at least one of the forward region and the rearward region of the own vehicle 40. Specifically, reference character 60 in FIG. 4 represents the searching area. The searching area 60 according to the first embodiment includes mainly at least a forward area for searching for one or more objects located in front of the own vehicle 40. The searching area 60 according to the first embodiment includes additionally a leftward area located leftward to the own vehicle 40, a rightward area located to the own vehicle 40, and a rearward area located behind the own vehicle 40. The reason why the searching area 60 is established to be wider, as set forth above, is to search the established aider searching area 60 for one or more objects that have a potential of becoming a factor for ghosts. Ghosts according to the first embodiment are false images detected at positions where there are no actual objects. Multiple reflection of radio waves represents a phenomenon that radio waves are repeatedly reflected by one or more objects at least two times.

As illustrated in FIG. 4, the trailer 41 has left and right edges, i.e., left and right corners, of the front end, each of which serves as a reference portion. The searching area 60 is established as the combination of (i) a first set of first and second searching areas established for the left-side radar device 10L and (ii) a second set of first and second searching areas established for the right-side radar device 10R.

The first searching area for the left-side radar device 10L is established to expand outwardly from a first reference line at a predetermined first angle θ₁ in the form of a fan shape; the first reference line connects between the left corner of the front end of the trailer 41. The second searching area for the left-side radar device 10L is established to expand outwardly from a second reference line at a predetermined second angle θ₂ in the form of a fan shape; the second reference line connects between the right corner of the front end of the trailer 41.

FIG. 4 illustrates only the first set of the first and second searching areas established for the left-side radar device 10L, and therefore illustration of the second set of the first and second searching areas established for the right-side radar device 10R is omitted. The second set of the first and second searching areas for the right-side radar device 10R can be established in the same manner as the first set of the first and second searching areas for the left-side radar device 10L.

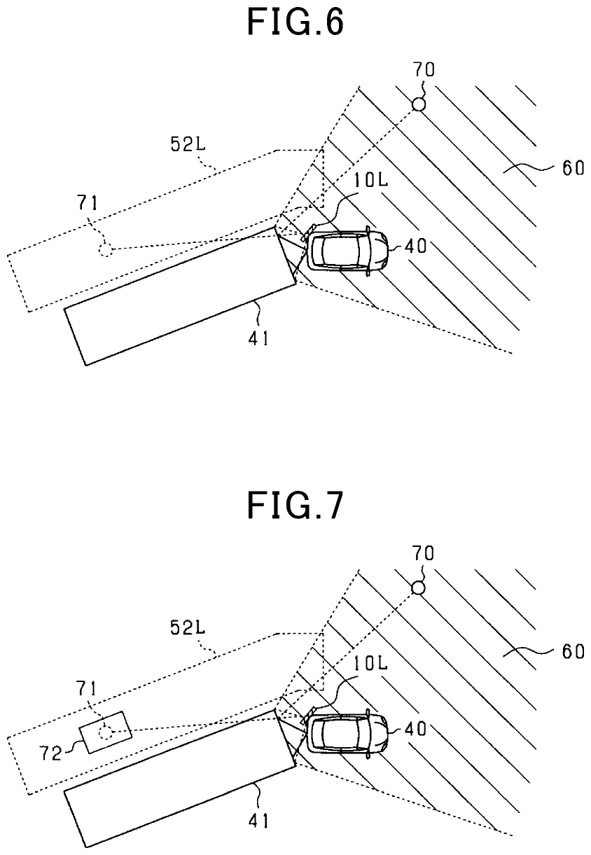

The following describes an example of how to calculate the first and second angles θ₁ and θ₂ with reference to FIGS. 5A and 5B.

As illustrated in FIGS. 5A and 5B, when viewed from above, the traveling direction of the own vehicle 40 is defined as an X-axis of an X-Y coordinate system, and a direction perpendicular to the traveling direction of the own vehicle 40 is defined as a Y-axis of the X-Y coordinate system. That is, in each of FIGS. 4, 5A and 5B, the traveling direction of the own vehicle 40 is the rightward direction of the corresponding one of FIGS. 4, 5A and 5B, so that the rightward direction of each of FIGS. 5A and 5B is the X-axis, and the upward direction of each of FIGS. 5A and 5B is the Y-axis. The X- and Y-axes defined in each of FIGS. 5A and 5B are similarly defined in each of the subsequent figures.

In each of FIGS. 5A and 5B, let us assume that
(I) Position coordinates at which the left-side radar device 10L is mounted in the X-Y coordinate system are defined as (X_{S}, Y_{S})
(II) An angle of the surface of the front end of the trailer 41 is defined as θₜ
(III) An incident angle from the left-side radar device 10L to the left corner of the front end of the trailer 41 is defined as θ_{SL}
(IV) An incident angle from the left-side radar device 10L to the right corner of the front end of the trailer 41 is defined as θ_{SR}
(V) Position coordinates of the left corner of the front end of the trailer 41 in the X-Y coordinate system are defined as (X_{TRL}, Y_{TRL})
(VI) Position coordinates of the right corner of the front end of the trailer 41 in the X-Y coordinate system are defined as (X_{TRR}, Y_{TRR})
   In this assumption, using trigonometric function enables the first and second angles θ₁ and θ₂ to be represented by the following formulas (1) and (2):

$${θ}_{1} = 2 {θ}_{SL} + 2 {θ}_{t} = 2 {tan}^{- 1} \{ \frac{{Y}_{TRL} - {Y}_{S}}{{X}_{S} - {X}_{TRL}} \} + 2 {θ}_{t} \qquad ( 1 )$$

$${θ}_{2} = 2 {θ}_{SR} - 2 {θ}_{t} = 2 {tan}^{- 1} \{ \frac{{Y}_{S} - {Y}_{TRR}}{{X}_{S} - {X}_{TRR}} \} - 2 {θ}_{t} \qquad ( 2 )$$

That is, the angle θₜ of the surface of the front end of the trailer 41 is defined based on an angle of the trailer 41 tilted to the traveling direction of the own vehicle 40. The angle θₜ of the surface of the front end of the trailer 41 becomes zero when, for example, a longitudinal direction of the trailer 41 is not tilted with the traveling direction of the own vehicle 40 (see FIG. 3B). Each of the left and right corners, i.e., left and right edges, of the front end of the trailer 41 is defined as the reference portion, but the present disclosure is not limited thereto. Specifically, each of left and right corners, i.e., left and right edges, of the rear end of the trailer 41 can be defined as the reference portion. As illustrated in FIG. 4, the orientation of the longitudinal length of each of the warning areas 52L and 52R changes depending on turning of the own vehicle 40.

Next, the following describes an example of how to calculate a position at which a ghost may occur with reference to FIG. 6. Hereinafter, a position at which a ghost may occur will also be referred to as a ghost occurrence position. The ghost position calculator 20f is configured to calculate the ghost occurrence position.

FIG. 6 illustrates an example situation where an object 70 is detected in a diagonally forward left region of the own vehicle 40. The following describes an example where the object 70 is an alternative vehicle different from the own vehicle 40. In FIG. 6, let us assume that the alternative vehicle 70 is detected by the radar device 10L. The alternative vehicle 70 is not necessarily detected by the radar device 10L. Reference character 71 represents a position where a ghost may occur due to the trailer 41 and the alternative vehicle 70. Radio waves emitted from the radar device 10L and multiply reflected by the surface of the front end of the trailer 41 and the alternative vehicle 70 may cause a ghost to occur at the position 71.

In FIG. 6, let us assume that
(I) Coordinates of the ghost occurrence position 71 in the X-Y coordinate system are defined as (X_{g}, Y_{g})
(II) A line passing through the surface of the front end of the trailer 41 in the X-Y coordinate system is defined as Y=aX+b
(III) Coordinates of the position of the alternative vehicle 70 are defined as (X_{FT}, Y_{FT})

In the expression Y=aX+b, a and b are constant values, each of which can be acquired from the trailer information.

In this assumption, the coordinates (X_{g}, Y_{g}) of the ghost occurrence position 71 in the X-Y coordinate system can be represented by the following formulas (3) and (4):

$${X}_{g} = \frac{1}{1 + {a}^{2}} \{ ( 1 - {a}^{2} ) {X}_{FT} + 2 {aY}_{FT} - 2 ab \} \qquad ( 3 )$$

$${Y}_{g} = \frac{2 a}{1 + {a}^{2}} ( {X}_{FT} + {aY}_{FT} - ab ) + b - {Y}_{FT} \qquad ( 4 )$$

Next, the following describes a margin area established to be added to the ghost occurrence position 71. Reference character 72 illustrated in FIG. 7 represents an area comprised of the ghost occurrence position 71 and the margin area added to surround the ghost occurrence position 71. The area 72 comprised of the ghost occurrence position 71 and the margin area serves as an area in which determination of whether there is a ghost is carried out. The area 72 will be therefore simply referred to as a ghost determination area. The ghost position calculator 20f is configured to calculate the margin area.

Any one of known methods of calculating the margin area can be freely used. In particular, the margin area can be calculated based on the size or speed of the alternative vehicle 70.

Preferably, the margin area can be calculated such that, the greater the size of the alternative vehicle 70, the greater the size of the calculated margin area, or the higher the traveling speed of the alternative vehicle 70, the greater the size of the calculated margin area.

Establishing the margin area around the alternative vehicle 70 enables an improvement of the accuracy of determining whether there is a ghost.

Alternatively, the margin area can be calculated based on both the size and the speed of the alternative vehicle 70.

In FIG. 7, the ghost determination area 72 has a rectangular or square shape, but the shape of the ghost determination area 72 is not limited thereto. Specifically, the ghost determination area 72 can have an elliptical shape or a diamond shape.

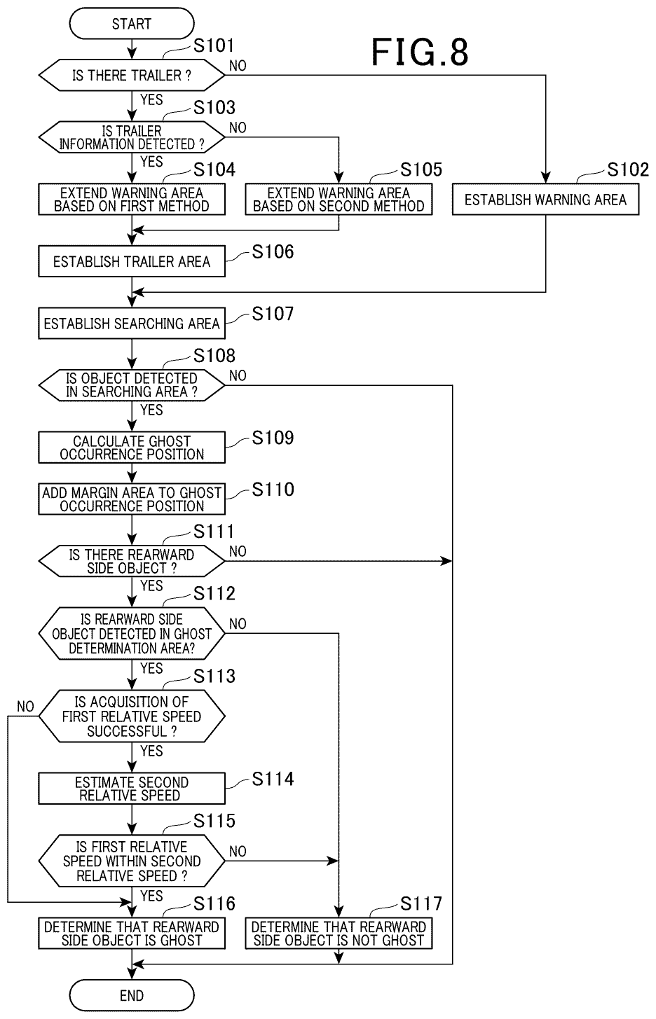

Next, the following describes an exemplary routine according to the first embodiment to be carried out by the ECU 20 with reference to a flowchart of FIG. 8. The ECU 20 is programmed to iterate the exemplary routine illustrated in FIG. 8 every predetermined cycle.

When starting the exemplary routine, the ECU 20 serves as the object recognizer 20b to determine whether there is a trailer 41, which is coupled to the rear end portion of the own vehicle 40, recognized as a rearward object located behind the own vehicle 40 in step S101. For example, the ECU 20 serves as the object recognizer 20b to acquire an image captured by the imaging device 11, and recognize the trailer 41 based on the captured image. The object recognizer 20b can perform the trailer recognition determination in step S101 based on another information. Specifically, the object recognizer 20b can perform the trailer recognition determination in step S101 based on information detected by at least one of the radar devices 10. If one or more other detection devices, such as an ultrasonic sensor, are mounted to the own vehicle 40, the object recognizer 20b can perform the trailer recognition determination in step S101 based on information detected by, for example, an ultrasonic sensor mounted to the own vehicle 40.

In response to response to determination that there is not a trailer 41 recognized as a rearward object located behind the own vehicle 40 (NO in step S101), the exemplary routine proceeds to step S102. In step S102, the ECU 20 serves as the warning area establishing unit 20d to establish the normal right-side warning area 51R located behind and to the right of the own vehicle 40, and the normal left-side warning area 51L located behind and to the left of the own vehicle 40 (see FIG. 3A). Thereafter, the exemplary routine proceeds to step S107.

Otherwise, in response to determination that there is a trailer 41 recognized as a rearward object located behind the own vehicle 40 (YES in step S101), the exemplary routine proceeds to step S103. In step S103, the ECU 20 serves as the warning area establishing unit 20d to refer to the trailer information to accordingly determine whether the length L of the trailer 41 is included in the trailer information. Although the trailer information includes various items of the trailer 41, there may be a case where all information items on the trailer 41 cannot be detected from the trailer 41. That is, the exemplary routine branches one of steps S104 and S105 depending on the result of determination whether the length L of the trailer 41 is included in the trailer information in step S103.

Specifically, in response determination that the length L of the trailer 41 is included in the trailer information (YES in step S103), the exemplary routine proceeds to step S104.

In step S104, the ECU 20 serves as the warning area establishing unit 20d refers to the length LT of the trailer 41 included in the trailer information to accordingly acquire the length LT of the trailer 41. Then, the ECU 20 serves as the warning area establishing unit 20d to perform a first method of extending backward the normal right- and left-side warning areas 51R and 51L in accordance with the length LT of the trailer 41, thus respectively establishing extended right- and left-side warning areas 52R and 52L (see FIG. 3B) in step S104.

Otherwise, in response determination that the length L of the trailer 41 is not included in the trailer information (NO in step S103), the exemplary routine proceeds to step S105.

In step S105, the ECU 20 serves as the warning area establishing unit 20d to perform a second method of extending backward the normal right- and left-side warning areas 51R and 51L in accordance with a predetermined length of, for example, 10 m.

In step S106, the ECU 20 serves as the trailer area establishing unit 20c to establish the trailer area 42 (see FIG. 3B) based on the information on the shape of the trailer 41 included in the trailer information.

Following the operation in step S106, the ECU 20 serves as the searching area establishing unit 20e to establish the searching area 60 for searching for one or more objects that are located around the own vehicle 40 and have a potential of becoming a factor for ghosts due to multiple reflection of radio waves by the one or more objects and the trailer 41 in step S107 (see FIG. 4).

Following the operation in step S107, the ECU 20 serves as the object recognizer 20b to perform at least one of a first determination of whether there is an object located in front of the own vehicle 40 and a second determination of whether there is an object located on at least one of the right and left sides of the own vehicle 40 in step S108. Specifically, the ECU 20 serves as the object recognizer 20b to determine whether there is an object detected in the searching area 60 in step S108.

In response to determination that there is an object detected in the searching area 60 (YES in step S108), the exemplary routine proceeds to step S109. Otherwise, in response to determination that there are no objects detected in the searching area 60 (NO in step S108), the ECU 20 terminates the exemplary routine.

Let us assume that, in step S109 and subsequent operations, an object detected in the searching area 60 is an alternative vehicle 70 different from the own vehicle 40 (see FIG. 6). The alternative vehicle 70 is not necessarily detected by the radar device 10L. The alternative vehicle 70 can be detected by the imaging device 11 mounted to, for example, the front portion of the own vehicle 40 or another radar device mounted to the front portion or a side portion of the own vehicle 40.

In step S109, the ECU 20 serves as the ghost position calculator 20f to calculate a ghost occurrence position at which a ghost is likely to occur due to the trailer 41 and the alternative vehicle 70. Because one example of how to calculate the ghost occurrence position has been described set forth above, descriptions of the operation in step S109 are omitted. After the operation in step S109, the exemplary routine proceeds to step S110.

In step S110, the ECU 20 serves as the ghost position calculator 20f to add a margin area to the ghost occurrence position (see reference character 71 in FIG. 7) to accordingly establish a ghost determination area 72 (see FIG. 7).

Next, the ECU 20 serves as the object recognizer 20b to determine whether there is a rearward side object detected by the radar device 10L or 10R behind and to the left or right of the own vehicle 40 in step S111.

In response to determination that there is a rearward side object detected by the radar device 10L or 10R behind and to the left or right of the own vehicle 40 (YES in step S111), the exemplary routine proceeds to step S112. Otherwise, in response to determination that there are no rearward side objects detected by the radar devices 10L and 10R behind and to either the left or right of the own vehicle 40 (NO in step S111), the ECU 20 terminates the exemplary routine.

In step S112, the ECU 20 serves as the ghost determiner 20j to determine whether the rearward side object is detected in the ghost determination area 72. Specifically, in step S112, the ECU 20 serves as the ghost determiner 20j to determine whether the position of the rearward side object detected by the radar device 10R or 10L is located in the ghost determination area 72.

In response to determination that the rearward side object is detected in the ghost determination area 72 (YES in step S112), the exemplary routine proceeds to step S113. Otherwise, in response to determination that the rearward side object is not detected in the ghost determination area 72 (NO in step S112), the exemplary routine proceeds to step S117. In step S117, the ECU 20 serves as the ghost determiner 20j to determine that the rearward side object is not a ghost due to the trailer 41 and the alternative vehicle 70, and thereafter terminates the exemplary routine.

In step S113, the ECU 20 serves as the relative speed acquiring unit 20g to perform a task of acquiring the relative speed of each of the alternative vehicle 70 and the rearward side object relative to the own vehicle 40 using a well-known method to accordingly determine whether acquisition of the relative speed of each of the alternative vehicle 70 and the rearward side object relative to the own vehicle 40 is successful.

When acquisition of the relative speed of each of the alternative vehicle 70 and the rearward side object relative to the own vehicle 40 is unsuccessful (NO in step S113), the exemplary routine proceeds to step S116. In step S116, the ECU 20 serves as the ghost determiner 20j to determine that the rearward side object is a ghost due to the trailer 41 and the alternative vehicle 70, and thereafter terminates the exemplary routine. That is, the ghost determiner 20j can be programmed to determine that the rearward side object is a ghost due to the trailer 41 and the alternative vehicle 70 in response to determination that the rearward side object is detected in the ghost determination area 72 (YES in step S112). In each of step S113 and subsequent steps S114 and S115, an actual object or a ghost is included in the rearward side object.

Otherwise, when acquisition of the relative speed of each of the alternative vehicle 70 and the rearward side object relative to the own vehicle 40 is successful (YES in step S113), the relative speed acquiring unit 20g recognizes the acquired relative speed of the rearward side object relative to the own vehicle 40 as a first relative speed of the rearward side object relative to the own vehicle 40. Then, the exemplary routine proceeds to step S114.

In step S114, the ECU 20 serves as the relative speed estimator 20h to estimate a second relative speed of the rearward side object relative to the own vehicle 40 based on the relative speed of the alternative vehicle 70 relative to the own vehicle 40, which is acquired by the relative speed acquiring unit 20g.

The following describes how to estimate the second relative speed of the rearward side object relative to the own vehicle 40 based on the relative speed of the alternative vehicle 70 relative to the own vehicle 40.

In the X-Y coordinate system, let us assume that
(I) X and Y components of the speed of the own vehicle 40 are defined as (V_{Sx}, V_{Sy})
(II) X and Y components of the relative speed of the alternative vehicle 70 relative to the own vehicle 40 are defined as (VFTₓ, VFT_{y})
(III) The angle of the surface of the front end of the trailer 41 is, as described above, defined as θₜ
(IV) X and Y components of the second relative speed of the rearward side object relative to the own vehicle 40 are defined as (V_{rel_gx}, V_{rel_gy})

In this assumption, the X and Y components (V_{rel_gx}, V_{rel_gy}) of the second relative speed of the rearward side object relative to the own vehicle 40 can be represented by the following formulas (5) and (6):

$${V}_{rel \_ gX} = ( {V}_{sX} - {V}_{FTX} ) cos ( 2 θ t ) - ( {V}_{FTY} - {V}_{SY} ) sin ( 2 θ t ) \qquad ( 5 )$$

$${V}_{rel \_ gY} = ( {V}_{FTY} - {V}_{SY} ) cos ( 2 θ t ) - ( {V}_{FTX} - {V}_{SX} ) sin ( 2 θ t ) \qquad ( 6 )$$

In step S114, the ECU 20 serves as the relative speed estimator 20h to calculate X-Y speed margin components to accordingly add the calculated X-Y speed margin components to the respective X and Y components (V_{rel_gx}, V_{rel_gy}) of the second relative speed of the rearward side object. In step S114, the relative speed estimator 20h can be programmed to calculate the X-Y speed margin components using, for example, the relative speed of the alternative vehicle 70 relative to the own vehicle 40. Alternatively, the relative speed estimator 20h can be programmed to calculate the X-Y speed margin components using one of well-known calculation methods.

Following the operation in step S114, the ECU 20 serves as the relative speed comparator 20i to compare X and Y components of the first relative speed of the rearward side object acquired by the relative speed acquiring unit 20g with the X and Y components (V_{rel_gx}, V_{rel_gy}) of the second relative speed of the rearward side object, to which the X-Y speed margin components have been respectively added, estimated by the relative speed estimator 20h in step S115.

When the result of the comparison shows that the X and Y components of the first relative speed of the rearward side object are respectively lower than or equal to the X and Y components (V_{rel_gx}, V_{rel_gy}) of the second relative speed of the rearward side object, to which the X-Y speed margin components have been added (YES in step S115), the exemplary routine proceeds to step S116. In step S116, the ECU 20 serves as the ghost determiner 20j to determine that the rearward side object is a ghost due to the trailer 41 and the alternative vehicle 70, and thereafter terminates the exemplary routine.

Otherwise, when the result of the comparison shows that at least one of the X and Y components of the first relative speed of the rearward side object is higher than the corresponding at least one of the X and Y components (V_{rel_gx}, V_{rel_gy}) of the second relative speed of the rearward side object, to which the X-Y speed margin components have been added (NO in step S115), the exemplary routine proceeds to step S117. In step S117, the ECU 20 serves as the ghost determiner 20j to determine that the rearward side object is not a ghost due to the trailer 41 and the alternative vehicle 70, and thereafter terminates the exemplary routine.

The set of the operations in steps S113 to S115 is programmed to determine whether the rearward side object is a ghost due to the trailer 41 and the alternative vehicle 70. For this reason, during the set of the operations in steps S113 to S115, the rearward side object has a first possibility of being an actual object or a second possibility of being a ghost. For this reason, if it is determined that the rearward side object is an actual object, the relative speed of the rearward side object results in logically the relative speed of the actual object. Similarly, if it is determined that the rearward side object is a ghost, the relative speed of the rearward side object results in logically the relative speed of the ghost.

The first embodiment achieves the following excellent benefits.

The ECU 20 of the first embodiment is configured to determine whether there is an object located in front of the own vehicle 40 or located on at least one of the right and left sides of the own vehicle 40; the object has a potential of becoming an occurrence factor for a ghost. Additionally, the ECU 20 is configured to determine whether there is a rearward object, which is different from a rearward side object as a recognition target, located behind the own vehicle 40.

In response to determination that (i) there is an alternative vehicle 70 as an object, which has a potential of becoming an occurrence factor for a ghost, located in front of the own vehicle 40 or located on at least one of the right and left sides of the own vehicle 40 and (ii) there is a trailer 41 as a rearward object located behind the own vehicle 40, the ECU 20 is configured to determine whether the rearward side object is a ghost due to the alternative vehicle 70 and the trailer 41 in accordance with a positional relationship between the alternative vehicle 70 and the trailer 41.

Specifically, because the ECU 20 recognizes the rearward side object using the radar devices 10, the positional relationship between the alternative vehicle 70 and the trailer 41 may cause multiple reflection of radio waves between the alternative vehicle 70 and the trailer 41. In this case, the recognized rearward side object may be a ghost due to the alternative vehicle 70 and the trailer 41.

From this viewpoint, the above configuration of the ECU 20 determines whether the rearward side object is a ghost due to the alternative vehicle 70 and the trailer 41. This therefore makes it possible to exclude a recognized rearward side object, which is determined to be a ghost, from a recognition target, thus reliably recognizing actual objects located behind the own vehicle 40. The object recognizer 20b serves as both a first determiner and a second determiner, and the ghost determiner 20j serves as a third determiner.

The ECU 20 is configured to establish, based on the positional relationship between the alternative vehicle 70 and the trailer 41, a ghost determination area 72 for determining whether there is a ghost behind the own vehicle 40. In response to determination that a rearward side object is detected in the ghost determination area 72, the ECU 20 is configured to determine that the rearward side object is a ghost due to the alternative vehicle 70 and the trailer 41. Because a ghost due to the alternative vehicle 70 and the trailer 41 is caused by multiple reflection of radio waves between the alternative vehicle 70 and the trailer 41, it is possible to establish, using the positional relationship between the alternative vehicle 70 and the trailer 41, the ghost determination area 72. If a rearward side object is detected in the ghost determination area 72, the detected rearward side object is likely to be a ghost due to the alternative vehicle 70 and the trailer 41. For this reason, the ECU 20 is configured to determine that the rearward side object detected in the ghost determination area 72 is a ghost due to the alternative vehicle 70 and the trailer 41. This therefore makes it possible to implement ghost determination with higher accuracy.

The ECU 20 is configured to establish the ghost determination area 72 based on at least one of size information on the size of the alternative vehicle 70 and speed information on the speed of the alternative vehicle 70. This also makes it possible to implement ghost determination with higher accuracy.

The ECU 20 is configured to acquire the relative speed of the rearward side object relative to the own vehicle 40. Then, in response to determination that the acquired relative speed of the rearward side object relative to the own vehicle 40 is within a predetermined range, i.e., lower than or equal to a predetermined threshold speed, the ECU 20 is configured to determine that the rearward side object is a ghost due to due to the alternative vehicle 70 and the trailer 41. That is, if the rearward side object is a ghost due to the alternative vehicle 70 and the trailer 41, the relative speed of the alternative vehicle 70 correlates with the relative speed of the trailer 41. The above configuration of the ECU 20 is based on the correlation between the relative speed of the alternative vehicle 70 and the relative speed of the trailer 41. This therefore makes it possible to implement ghost determination with higher accuracy.

An example of the rear object is a towed vehicle, such as a trailer 41, coupled with the rear portion of the own vehicle 40. Such a towed vehicle is different from other vehicles, such as passenger vehicles around the own vehicle 40. A towed vehicle is located behind the own vehicle 40 and located adjacently to the own vehicle 40 within a predetermined distance from the own vehicle 40. The width of such a towed vehicle may be wider than that of the own vehicle 40. For these reasons, such a towed vehicle may be likely to reflect radio waves, so that a towed vehicle may cause ghosts to be more likely to occur as compared with a normal vehicle. That is, the above configuration of the ECU 20 makes it possible to reduce execution of one or more collision inhibition operations against a ghost caused by such a towed vehicle.

The ECU 20 can be configured to output a first signal for execution of one or more collision inhibition operations against a rearward side object, and a second signal for reducing execution of one or more collision inhibition operations against a rearward side object that is determined to be a ghost due to the alternative vehicle 70 and the trailer 41. This makes it possible to reduce erroneous issuance of a warning due to a ghost.

### Second Embodiment

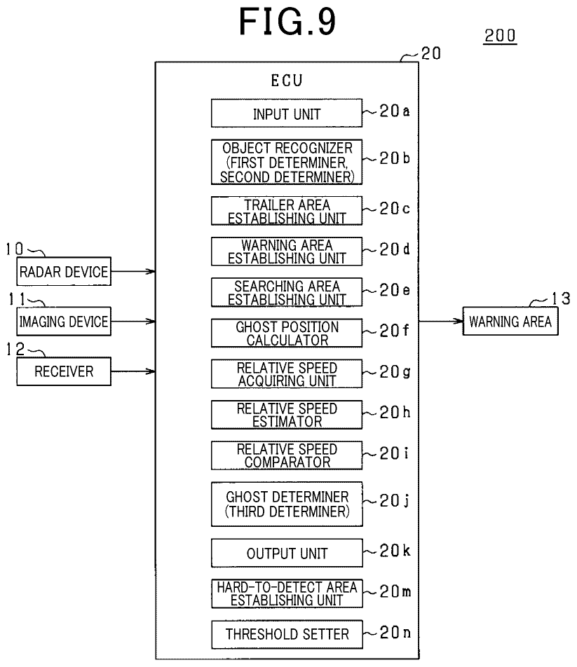

The following describes a surroundings monitoring system 200 according to the second embodiment with reference to FIGS. 9 to 11.

A different point of the second embodiment from the first embodiment is that an ECU 20 of the surroundings monitoring system 200 additionally includes, as illustrated in FIG. 9, a hard-to-detect area establishing unit 20m and a threshold setter 20n. In the first and second embodiments, descriptions of like parts, to which like reference characters are assigned as much as possible, are omitted or simplified to avoid redundant description. The following describes mainly the different points of the second embodiment from the first embodiment.

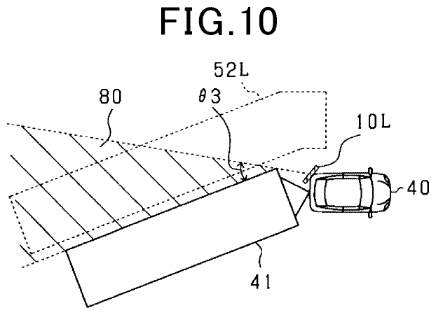

The following describes a hard-to-detect area established by the hard-to-detect area establishing unit 20m with reference to FIG. 10.

The hard-to-detect area according to the second embodiment is defined as an area in which it is hard for the radar devices 10 to detect one or more objects due to the size of the trailer 41. The hard-to-detect area 80 is represented by reference character 80 in FIG. 10. The hard-to-detect area 80 is different from a so-called blind spot. The size and location of the hard-to-detect area 80 are determined in accordance with the mount positions of the radar devices 10 and the size of the trailer area 42, i.e., the planar size of the trailer 41. In FIG. 10, because the size of the trailer area 42 is identical to the planar size of the trailer 41, illustration of the trailer area 42 is omitted. In FIG. 10, the trailer area 41 can be alternatively read as the trailer area 42. The size of the trailer 41 may include, for example, the lateral width of the trailer 41 and/or the size of the surface of the front end of the trailer 41; the front end of the trailer 41 is one of both ends of the trailer 41 in its longitudinal direction, which faces the own vehicle 40.

The hard-to-detect area establishing unit 20m can be configured to establish the hard-to-detect area 80 based on a third angle θ₃ illustrated in FIG. 10.

The following describes an example of how to calculate the third angle θ₃.

In an example situation illustrated in FIG. 10, let us assume that
(I) The position coordinates at which the left-side radar device 10L is mounted in the X-Y coordinate system are defined as (X_{S}, Y_{S})
(II) The angle of the surface of the front end of the trailer 41 is defined as θₜ
(III) The incident angle from the left-side radar device 10L to the left corner of the front end of the trailer 41 is defined as θ_{SL}
(IV) The position coordinates of the left corner of the front end of the trailer 41 in the X-Y coordinate system are defined as (X_{TR}, Y_{TR})

In this assumption, using trigonometric function enables the third angle θ₃ to be represented by the following formula (7):

$$0 < {θ}_{3} \leq = {tan}^{- 1} \{ \frac{{Y}_{TR} - {Y}_{S}}{{X}_{S} - {X}_{TR}} \} + {θ}_{t} \qquad ( 7 )$$

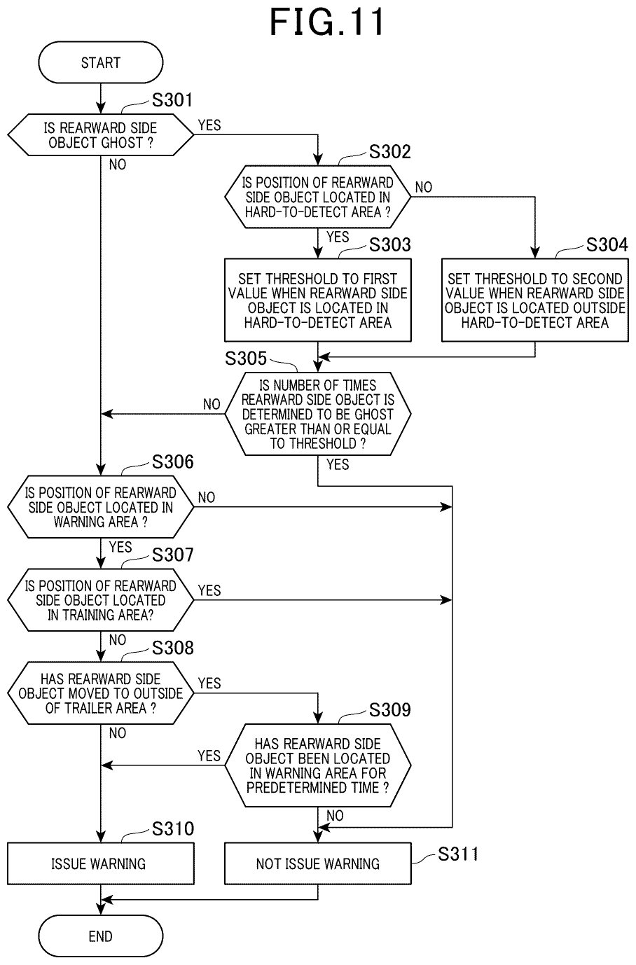

Next, the following describes an exemplary routine according to the second embodiment to be carried out by the ECU 20 with reference to a flowchart of FIG. 11. The exemplary routine according to the second embodiment continues from the exemplary routine illustrated in FIG. 8. Specifically, in the exemplary routine illustrated in FIG. 11, an affirmative determination (YES) in step S301 represents the subsequent operation from the operation in step S116 illustrated in FIG. 8, and a negative determination (NO) in step S301 represents the subsequent operation from the operation in step S117 illustrated in FIG. 8.

Following the affirmative determination in step S301, the ECU 20 serves as the ghost determiner 20j to determine whether the position of the rearward side object, which is determined as a ghost, is located in the hard-to-detect area 80 in step S302.

In response to determination that the position of the rearward side object, which is determined as a ghost, is located in the hard-to-detect area 80 (YES in step S302), the exemplary routine proceeds to step S303. Otherwise, in response to determination that the position of the rearward side object, which is determined as a ghost, is located outside the hard-to-detect area 80 (NO in step S302), the exemplary routine proceeds to step S304.

In step S303, the ECU 20 serves as the threshold setter 20n to set, to a first value, a threshold for determining whether to issue a warning for the first case where the rearward side object, which is determined as a ghost, is located in the hard-to-detect area 80. Similarly, in step S304, the ECU 20 serves as the threshold setter 20n to set the threshold to a second value for the second case where the rearward side object, which is determined as a ghost, is located outside the hard-to-detect area 80.

Specifically, the ECU 20 according to the first embodiment can be configured not to instruct the warning device 13 to issue a warning in response to determination that the rearward side object is a ghost.

In contrast, the ECU 20 according to the second embodiment is configured to perform a determination task of determining whether the rearward side object is a ghost predetermined times for a predetermined period. Then, the ECU 20 according to the second embodiment is configured not to instruct the warning device 13 to issue a warning in response to determination that the number of times the rearward side object is determined to be a ghost is greater than or equal to the threshold. Like the first embodiment, this configuration makes it possible to reduce erroneous issuance of a warning due to a ghost.

The ECU 20 according to the first embodiment can be configured to perform the determination task predetermined times for a predetermined period, and configured not to instruct the warning device 13 to issue a warning in response to determination that the number of times the rearward side object is determined to be a ghost is greater than or equal to the threshold.

In particular, the ECU 20 serves as the threshold setter 20n to set the threshold to the first value for the first case where the rearward side object, which is determined as a ghost, is located in the hard-to-detect area 80; the first value is smaller than the second value used for the second case where the rearward side object, which is determined as a ghost, is located outside the hard-to-detect area 80. For example, the first value is set to 2, and the second value is set to 4.

Following the operation in step S303 or S304, the ECU 20 determines whether the number of times the rearward side object is determined to be a ghost (YES in step S301) is greater than or equal to the threshold for the predetermined period in step S305.

For example, the predetermined period is set to a period corresponding to an execution period of the latest first to fifth cycles of the exemplary routine illustrated in FIGS. 8 and 11; the most recent cycle is the first cycle, and the most previous cycle is the fifth cycle. Let us assume that the result of the determination that the rearward side object is determined to be a ghost (YES in step S301) is represented as 1, and that the result of the determination that the rearward side object is determined not to be a ghost (NO in step S301) is represented as 0.

In this assumption, the results of the determination that the rearward side object is determined to be a ghost or not to be a ghost for the respective first, second, third, fourth, and fifth cycles are represented as (1, 0, 0, 1, 0). If a sampling period is set to 10 msec, the latest first to fifth cycles of the exemplary routine illustrated in FIGS. 8 and 11 means 50 msec in terms of time.

That is, the result (1, 0, 0, 1, 0) represents that the number of times the rearward side object is determined to be a ghost for the latest first to fifth cycles is 2.

For this reason, if each of the first to fifth cycles executes the operation in step S303 so that the threshold is set to the first value of 2, the determination in step S305 is affirmative (YES in step S305). Otherwise, if each of the first to fifth cycles executes the operation in step S304 so that the second value is set to the second value of 4, the determination in step S305 is negative (NO in step S305).

In response to determination that the determination in step S305 is affirmative (YES in step S305), the ECU 20 does not instruct the warning device 13 to issue a warning. Otherwise, in response to determination that the determination in step S305 is negative (NO in step S305), the exemplary routine proceeds to step S306.

The reason why the ECU 20 changes the threshold between the first value and the second value depending on whether the position of the rearward side object, which is determined to be a ghost, is located in or outside the hard-to-detect area 80 is that, because if a rearward side object located in the hard-to-detect area 80 is determined to be a ghost, the rearward side object located in the hard-to-detect area 80 is highly likely to be a ghost, it is preferable to determine not to issue a warning as early as possible.

In step S306, the ECU 20 determines whether the position of the rearward side object is located in the warning area 52L. In response to determination that the position of the rearward side object is located in the warning area 52L (YES in step S306), the exemplary routine proceeds to step S307. Otherwise, in response to determination that the position of the rearward side object is located outside the warning area 52L (NO in step S306), the exemplary routine proceeds to step S311.

In step S307, the ECU 20 determines whether the position of the rearward side object is located in the trailer area 42. The reason why the ECU 20 performs the determination of whether the position of the rearward side object is located in the warning area 52L is that turning of the own vehicle 40 with the trailer 41 coupled therewith may result in the warning area 52L overlapping the trailer area 42.

In response to determination that the position of the rearward side object is located outside the trailer area 42 (NO in step S307), the exemplary routine proceeds to step S308. Otherwise, in response to determination that the position of the rearward side object is located in the trailer area 42 (YES in step S307), the exemplary routine proceeds to step S311.

In step S308, the ECU 20 determines whether the rearward side object has moved from the inside of the trailer area 42 to the outside of the trailer area 42.

In response to determination that the rearward side object has moved from the inside of the trailer area 42 to the outside of the trailer area 42 (YES in step S308), the exemplary routine proceeds to step S309. Otherwise, in response to determination that the rearward side object has not moved from the inside of the trailer area 42 to the outside of the trailer area 42 (NO in step S308), the exemplary routine proceeds to step S310.

In step S309, the ECU 20 determines whether the rearward side object has been located in the warning area 52L for at least a predetermined time. In response to determination that the rearward side object has been located in the warning area 52L for at least the predetermined time (YES in step S309), the exemplary routine proceeds to step S310. In step S310, the ECU 20 instructs the warning device 13 to issue a warning.

Otherwise, in response to determination that the rearward side object has not been located in the warning area 52L for at least the predetermined time (NO in step S309), the exemplary routine proceeds to step S311. In step S311, the ECU 20 does not instruct the warning device 13 to issue a warning.

The second embodiment achieves the following excellent benefits.

The ECU 20 of the second embodiment is configured to establish the hard-to-detect area 80 in which it is hard for the radar devices 10 to detect one or more objects due to the size of the trailer 41. The ECU 20 is configured to determine whether the position of the rearward side object is located in the hard-to-detect area 80. Then, the ECU 20 is configured to cause the rearward object to be more likely to be determined as a ghost as compared with a second case where the position of the rearward side object is located outside the hard-to-detect area 80.

The greater the size of the trailer 41 as compared with the sizes of other vehicles, such as passenger vehicles, around the own vehicle 40, the greater the size of the hard-to-detect area 80. If a rearward side object located in such a hard-to-detect area 80 is determined to be a ghost due to the alternative vehicle 70 and the trailer 41, it is preferable to determine not to issue a warning as early as possible.

From this viewpoint, the ECU 20 is configured to set the threshold to be in a first case where the rearward side object is located in the hard-to-detect area 80 smaller as compared with a second case where the rearward side object is located outside the hard-to-detect area 80, thus causing the rearward object to be more likely to be determined as a ghost. This there makes it possible to determine not to issue a warning as early as possible.

### Modifications

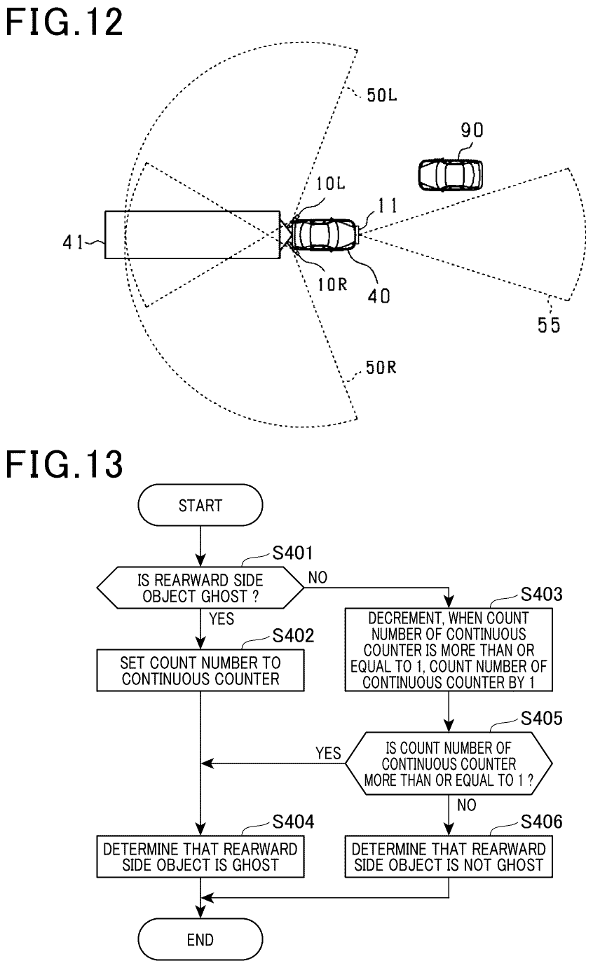

The following describes a typical modification of the first and second embodiments with reference to FIGS. 12 and 13.

FIG. 12 illustrates an example situation where the own vehicle 40 and an alternative vehicle 90, which has been located in a detection range 55 of the imaging device 11 of the own vehicle 40 move so that the alternative vehicle 90 moves into a blind spot of the imaging device 11.

In this situation, when the ghost determiner 20j has performed determination that the rearward side object is a ghost until the alternative vehicle 90 moves into the blind spot of the imaging device 11, the ghost determiner 20j can be configured to continue the determination that the rearward side object is a ghost. This configuration enables continuous determination that the rearward side object is a ghost even after the alternative vehicle 90 moves into the blind spot of the imaging device 11.

For example, after the alternative vehicle 90 moves into the blind spot of the imaging device 11, the ECU 20 can be configured to continue the determination that the rearward side object is a ghost until a continuous counter reaches a predetermined count number.

The following describes an exemplary routine according to the typical modification to be carried out by the ECU 20 with reference to a flowchart of FIG. 13. The exemplary routine is cyclically carried out assuming that the alternative vehicle 90 is detected based on images captured by the imaging device 11 and the alternative vehicle 90 moves into the blind spot of the imaging device 11. The exemplary routine according to the typical modification is applied to the above situation where the alternative vehicle 90 moves into the blind spot of the imaging device 11, but can be applied to other situations where the alternative vehicle 90 is detected by one or more of the detection devices installed in the own vehicle 40, such as the radar devices 10, the imaging device 11, a panoramic view monitor, or a sonar, and the alternative vehicle 90 moves into the blind spot of the one of the detection devices.

In step S401 of the exemplary routine, the ECU 20 serves as the ghost determiner 20 to determine whether the rearward side object is a ghost due to the trailer 41 and the alternative vehicle 90 set forth above.

In response to determination that the rearward side object is a ghost due to the trailer 41 and the alternative vehicle 90 (YES in step S401), the exemplary routine proceeds to step S402.

In step S402, the ECU 20, which stores the continuous counter, serves as the ghost determiner 20j to set a predetermined threshold, i.e., a predetermined count number, to the continuous counter. The threshold is variably set depending on the reliability of the detection device with the blind spot in which the alternative vehicle 90 is located. If the reliability of the detection device is relatively high, the continuous counter is set to the threshold of 5. Additionally, if the reliability of the detection device is relatively low, the threshold of 3 can be set to the continuous counter. As described above, the higher the reliability of the detection device is, the greater the threshold set to the continuous counter is. The threshold set to the continuous counter can be freely changed. The threshold set to the continuous counter can be changed depending on the size of the blind spot of the detection device. For example, if the size of the blind spot of the detection device is relatively large, the continuous counter can be set to the threshold of 5. Additionally, if the size of the blind spot of the detection device is relatively small, the continuous counter can be set to the threshold of 3.

Let us assume the following first to third patterns. The first pattern uses only the imaging device 11, the second pattern uses both the one or more radar devices 10 and the imaging device 11, and the third pattern uses the imaging device 11, the panoramic view monitor, and the one or more sonars; the panoramic view monitor and the one or more sonars serve as the other detection devices.

Because the size of the blind spot of the first pattern is larger than that of the blind spot of each of the second and third patterns, the continuous counter can be set to the threshold of 5 for the first pattern. Because the size of the blind spot of the second pattern is smaller than that of the blind spot of the first pattern and larger than the third pattern, the continuous counter can be set to the threshold of 3 for the second pattern. Because the third pattern has no blind spot, the continuous counter can be set to the threshold of 0 for the third pattern.

Following the operation in step S402, the ECU 20 serves as the ghost determiner 20j to continue the determination that the rearward side object is a ghost due to the alternative vehicle 90 and the trailer 41 upon determination that the count number, i.e., the threshold, of the continuous counter has not reached zero in step S404, and thereafter the ECU 20 terminates the exemplary routine.

Otherwise, in response to determination that the rearward side object is not a ghost due to the trailer 41 and the alternative vehicle 90 (NO in step S401), the exemplary routine proceeds to step S403. In step S403, the ECU 20 decrements the count number of the continuous counter by 1 upon determination that the count number of the continuous counter is more than or equal to 1.

Following the operation in step S403, the ECU 20 determines whether the count value of the continuous counter is more than or equal to 1 in step S405. Upon determination that the count value of the continuous counter is more than or equal to 1 (YES in step S405), the ECU 20 serves as the ghost determiner 20j to continue the determination that the rearward side object is a ghost due to the alternative vehicle 90 and the trailer 41 in step S404, and thereafter the ECU 20 terminates the exemplary routine. Otherwise, upon determination that the count value of the continuous counter is less than 1 (NO in step S405), the ECU 20 serves as the ghost determiner 20j to determine that the rearward side object is not a ghost in step S406, and thereafter the ECU 20 terminates the exemplary routine.

Accordingly, the ECU 20 of the typical modification makes it possible to continue the determination that the rearward side object is a ghost even after the alternative vehicle 90, which has been detected by the detection device, moves into the blind spot of the detection device.

Each of the first and second embodiments has described a trailer 41 located behind the own vehicle 40 as a rearward object that may cause a ghost, but a rearward object located behind the own vehicle 40, which may cause a ghost, is not limited to such a trailer 41. Specifically, any object, which has any size and any shape, located behind the own vehicle 40 may be recognized as a rearward object that may cause a ghost as long as the object can reflect radio waves. That is, any object comprised of a rigid body or a point mass can be recognized as a rearward object that may cause a ghost as long as the object can reflect radio waves. That is, any stationary object or any movable object can be recognized as a rearward object that may cause a ghost as long as the stationary object or the movable object can reflect radio waves. For example, an object located behind the own vehicle 40 and within a predetermined range from the own vehicle 40 can be recognized as a rearward object. A normal vehicle, such as a passenger vehicle, a signboard, or a wall may be recognized as such a rearward object. If an object other than a trailer is recognized as a rearward object, it is possible to acquire (i) the angle of the surface of the front end of the object and (ii) the shape of the object using one or more millimeter-wave radars, one or more cameras, detection sensors other than the radars and cameras, and/or external communications in cooperation with maps. That is, even if a normal vehicle, such as a passenger vehicle, a signboard, or a wall is recognized as a rearward object, it is possible to establish a hard-to-detect area and determine whether a recognized rearward object is a ghost based on the hard-to-detect area according to the second embodiment.

Each of the first and second embodiments has described an alternative vehicle as an object located in front of the own vehicle 40, but an object located in front of the own vehicle 40 is not limited to such a movable object. Specifically, the present disclosure can be applied to a case where a stationary object, such as a road cone, a fallen object, a wall, or a guardrail is used as an object located in front of the own vehicle 40.

In response to determination that the rearward side object is detected in the ghost determination area 72 (YES in step S112), the ECU 20 can be configured to determine that the rearward side object is a ghost due to the trailer 41 and the alternative vehicle 70 without calculating and outputting other object information, such as the position and/or speed of the rearward side object. This therefore makes it possible to reduce the processing load of the ECU 20.

The control apparatuses and their control methods described in the present disclosure can be implemented by a dedicated computer including a memory and a processor programmed to perform one or more functions embodied by one or more computer programs.

The control apparatuses and their control methods described in the present disclosure can also be implemented by a dedicated computer including a processor comprised of one or more dedicated hardware logic circuits.

The control apparatuses and their control methods described in the present disclosure can further be implemented by a processor system comprised of a memory, a processor programmed to perform one or more functions embodied by one or more computer programs, and one or more hardware logic circuits.

The one or more programs can be stored in a computer-readable non-transitory storage medium as instructions to be carried out by a computer.

The present disclosure includes the following specific configurations extracted from the above exemplary embodiments.

### [Configuration I]

The configuration I provides a surroundings monitoring apparatus (20) for recognizing, based on detection information acquired from a radio-wave transceiver (10), a rearward side object located behind and to a right or left side of an own vehicle (40). The radio-wave transceiver has a detection range located behind and to the right or left side of the own vehicle. The surroundings monitoring apparatus includes a first determiner configured to determine whether an object is located at least in front of or on a right or left side of the own vehicle, and a second determiner configured to determine whether a rearward object, which is different from the rearward side object as a recognition target is located behind the own vehicle. The surroundings monitoring apparatus includes a third determiner configured to, in response to determination that (i) the object is located at least in front of or on the right or left side of the own vehicle and (ii) the rearward object is located behind the own vehicle, determine, based on a positional relationship between the object determined by the first determiner and the rearward object determined by the second determiner, whether the rearward side object is a ghost due to the object determined by the first determiner and the rearward object determined by the second determiner.

### [Configuration II]

The configuration II depends from the configuration I. Specifically, the surroundings monitoring apparatus according to the configuration II includes a determination area establishing unit configured to establish, based on the positional relationship between the object determined by the first determiner and the rearward object determined by the second determiner, a ghost determination area in which determination of whether the rearward side object is a ghost is carried out. The third determiner is configured to determine, in response to determination that the rearward side object is located in the ghost determination area, that the rearward side object is a ghost.

### [Configuration III]

The configuration III depends from the configuration I or II. Specifically, the determination area establishing unit of the configuration III is configured to establish the ghost determination area in accordance with information on at least one of a size and a speed of the object determined by the first determiner.

### [Configuration IV]

The configuration IV depends from any one of the configurations I to III. Specifically, the surroundings monitoring apparatus according to the configuration IV includes a searching area establishing unit configured to establish an object searching area located at least in front of or on the right or left side of the own vehicle in accordance with a positional relationship between the radio-wave transceiver and the rearward object. The first determiner is configured to determine whether an object is located in the searching area established by the searching area establishing unit.

### [Configuration V]

The configuration V depends from any one of the configurations I to IV. Specifically, the surroundings monitoring apparatus according to the configuration V includes a relative speed acquisition unit configured to acquire a relative speed of the rearward side object relative to the own vehicle. The third determiner is configured to determine, in response to determination that the relative speed of the rearward side object is within a predetermined range, that the rearward side object is a ghost.

### [Configuration VI]

The configuration VI depends from any one of the configurations I to V. Specifically, the rearward object is a towed vehicle coupled with a rear portion of the own vehicle.

### [Configuration VII]

The configuration VII depends from any one of the configurations I to VI. Specifically, the surroundings monitoring apparatus according to the configuration VII includes a hard-to-detect area establishing unit configured to establish a hard-to-detect area defined as an area in which detection by the radar-wave transceiver is hard. The third determiner is configured to cause the rearward side object to be more likely to be determined as a ghost in a first case where the rearward side object is located in the hard-to-detect area as compared with a second case where the rearward side object is located outside the hard-to-detect area.

### [Configuration VIII]

The configuration VIII depends from any one of the configurations I to VII. Specifically, the first determiner is configured to determine, based on a detection range of a detection device acquired from the detection device, whether an object is located at least in front of or on the right or left side of the own vehicle. The third determiner is configured to, even when the rearward side object, which has been determined to be a ghost, moves outside the detection range of the detection device, continue determination that the rearward side object is a ghost.

### [Configuration IX]

The configuration IX depends from any one of the configurations I to VIII. Specifically, the surroundings monitoring apparatus of the configuration IX includes an output unit configured to output (i) a first signal for execution of one or more collision inhibition operations that inhibit a collision of the own vehicle 40 with the rearward side object, and (ii) a second signal for reducing execution of the one or more collision inhibition operations against the rearward side object in response to determination that the rearward side object is a ghost.

While the illustrative exemplary embodiments of the present disclosure have been described herein, the present disclosure is not limited to the exemplary embodiment and its configuration described herein. Specifically, the present disclosure includes various modifications and/or alternatives within the scope of the present disclosure. In addition to various combinations and forms, other combinations and forms including one or more/less elements thereof are also within the inventive principle and scope of the present disclosure.

1. A surroundings monitoring apparatus for recognizing, based on detection information acquired from a radio-wave transceiver, a rearward side object located behind and to a right or left side of an own vehicle, the radio-wave transceiver having a detection range located behind and to the right or left side of the own vehicle, the surroundings monitoring apparatus comprising:
a first determiner configured to determine whether an object is located at least in front of or on a right or left side of the own vehicle;
a second determiner configured to determine whether a towed vehicle is located behind the own vehicle, the towed vehicle being coupled with the own vehicle, the towed vehicle having a front end and a rear end;
a third determiner configured to, in response to determination that (i) the object is located at least in front of or on the right or left side of the own vehicle and (ii) the towed vehicle is located behind the own vehicle, determine, based on a positional relationship between the object determined by the first determiner and the towed vehicle determined by the second determiner, whether the rearward side object is a ghost due to the object determined by the first determiner and the towed vehicle determined by the second determiner; and
a searching area establishing unit configured to establish an object searching area located at least in front of or on the right or left side of the own vehicle in accordance with:
(i) a position of the radio-wave transceiver;
(ii) at least one of a position of each of left and right edges of the front end of the towed vehicle and a position of each of left and right edges of the rear end of the towed vehicle; and
(iii) an angle of the towed vehicle tilted to a traveling direction of the own vehicle, wherein:
the first determiner is configured to determine whether an object is located in the searching area established by the searching area establishing unit.

2. The surroundings monitoring apparatus according to claim 1, further comprising:
a determination area establishing unit configured to establish, based on the positional relationship between the object determined by the first determiner and the towed vehicle determined by the second determiner, a ghost determination area in which determination of whether the rearward side object is a ghost is carried out, wherein:
the third determiner is configured to determine, in response to determination that the rearward side object is located in the ghost determination area, that the rearward side object is a ghost.

3. The surroundings monitoring apparatus according to claim 2, wherein:
the determination area establishing unit is configured to establish the ghost determination area in accordance with information on at least one of a size and a speed of the object determined by the first determiner.

4. The surroundings monitoring apparatus according to claim 1, further comprising:
a relative speed acquisition unit configured to acquire a relative speed of the rearward side object relative to the own vehicle, wherein:
the third determiner is configured to determine, in response to determination that the relative speed of the rearward side object is within a predetermined range, that the rearward side object is a ghost.

5. The surroundings monitoring apparatus according to claim 1, further comprising:
a hard-to-detect area establishing unit configured to establish a hard-to-detect area defined as an area in which detection by the radar-wave transceiver is hard, wherein:
the third determiner is configured to cause the rearward side object to be more likely to be determined as a ghost in a first case where the rearward side object is located in the hard-to-detect area as compared with a second case where the rearward side object is located outside the hard-to-detect area.

6. The surroundings monitoring apparatus according to claim 1, wherein:
the first determiner is configured to determine, based on a detection range of a detection device acquired from the detection device, whether an object is located at least in front of or on the right or left side of the own vehicle; and
the third determiner is configured to, even when the rearward side object, which has been determined to be a ghost, moves outside the detection range of the detection device, continue determination that the rearward side object is a ghost.

7. The surroundings monitoring apparatus according to claim 1, further comprising:
an output unit configured to output:
a first signal for execution of one or more collision inhibition operations that inhibit a collision of the own vehicle 40 with the rearward side object; and
a second signal for reducing execution of the one or more collision inhibition operations against the rearward side object in response to determination that the rearward side object is a ghost.

8. A surroundings monitoring apparatus for recognizing, based on detection information acquired from a radio-wave transceiver, a rearward side object located behind and to a right or left side of an own vehicle, the radio-wave transceiver having a detection range located behind and to the right or left side of the own vehicle, the surroundings monitoring apparatus comprising:
a first determiner configured to determine whether an object is located at least in front of or on a right or left side of the own vehicle;
a second determiner configured to determine whether a towed vehicle is located behind the own vehicle, the towed vehicle being coupled with the own vehicle, the towed vehicle having a front end and a rear end;
a third determiner configured to, in response to determination that (i) the object is located at least in front of or on the right or left side of the own vehicle and (ii) the towed vehicle is located behind the own vehicle, determine, based on a positional relationship between the object determined by the first determiner and the towed vehicle determined by the second determiner, whether the rearward side object is a ghost due to the object determined by the first determiner and the towed vehicle determined by the second determiner; and
a hard-to-detect area establishing unit configured to establish a hard-to-detect area defined as an area in which detection by the radar-wave transceiver is hard, wherein:
the third determiner is configured to cause the rearward side object to be more likely to be determined as a ghost in a first case where the rearward side object is located in the hard-to-detect area as compared with a second case where the rearward side object is located outside the hard-to-detect area.

9. The surroundings monitoring apparatus according to claim 8, further comprising:
a determination area establishing unit configured to establish, based on the positional relationship between the object determined by the first determiner and the towed vehicle determined by the second determiner, a ghost determination area in which determination of whether the rearward side object is a ghost is carried out, wherein:
the third determiner is configured to determine, in response to determination that the rearward side object is located in the ghost determination area, that the rearward side object is a ghost.

10. The surroundings monitoring apparatus according to claim 9, wherein:
the determination area establishing unit is configured to establish the ghost determination area in accordance with information on at least one of a size and a speed of the object determined by the first determiner.

11. The surroundings monitoring apparatus according to claim 8, further comprising:
a searching area establishing unit configured to establish an object searching area located at least in front of or on the right or left side of the own vehicle in accordance with:
(i) a position of the radio-wave transceiver;
(ii) at least one of a position of each of left and right edges of the front end of the towed vehicle and a position of each of left and right edges of the rear end of the towed vehicle; and
(iii) an angle of the towed vehicle tilted to a traveling direction of the own vehicle,
the first determiner being configured to determine whether an object is located in the searching area established by the searching area establishing unit,
the third determiner being configured to determine, in response to determination that the rearward side object is located in the ghost determination area, that the rearward side object is a ghost.

12. The surroundings monitoring apparatus according to claim 8, wherein:
the first determiner is configured to determine, based on a detection range of a detection device acquired from the detection device, whether an object is located at least in front of or on the right or left side of the own vehicle; and
the third determiner is configured to, even when the rearward side object, which has been determined to be a ghost, moves outside the detection range of the detection device, continue determination that the rearward side object is a ghost.

13. The surroundings monitoring apparatus according to claim 8, further comprising:
an output unit configured to output:
a first signal for execution of one or more collision inhibition operations that inhibit a collision of the own vehicle 40 with the rearward side object; and
a second signal for reducing execution of the one or more collision inhibition operations against the rearward side object in response to determination that the rearward side object is a ghost.

14. A processor program product including:
a non-transitory storage medium readable by a processor for recognizing, based on detection information acquired from a radio-wave transceiver, a rearward side object located behind and to a right or left side of an own vehicle, the radio-wave transceiver having a detection range located behind and to the right or left side of the own vehicle; and
control program instructions stored in the non-transitory storage medium,
the control program instructions cause the processor to:
perform a first determination step of determining whether an object is located at least in front of or on a right or left side of the own vehicle;
perform a second determination step of determining whether a towed vehicle is located behind the own vehicle, the towed vehicle being coupled with the own vehicle, the towed vehicle having a front end and a rear end;
determine, in response to determination that (i) the object is located at least in front of or on the right or left side of the own vehicle and (ii) the towed vehicle is located behind the own vehicle, whether the rearward side object is a ghost due to the object determined by the first determination step and the towed vehicle determined by the second determination step based on a positional relationship between the object determined by the first determination step and the towed vehicle determined by the second determination step; and
establish an object searching area located at least in front of or on the right or left side of the own vehicle in accordance with:
(i) a position of the radio-wave transceiver;
(ii) at least one of a position of each of left and right edges of the front end of the towed vehicle and a position of each of left and right edges of the rear end of the towed vehicle; and
(iii) an angle of the towed vehicle tilted to a traveling direction of the own vehicle, wherein
the first determination step is configured to determine whether an object is located in the established searching area.

15. A processor program product including:
a non-transitory storage medium readable by a processor for recognizing, based on detection information acquired from a radio-wave transceiver, a rearward side object located behind and to a right or left side of an own vehicle, the radio-wave transceiver having a detection range located behind and to the right or left side of the own vehicle; and
control program instructions stored in the non-transitory storage medium,
the control program instructions cause the processor to:
perform a first determination step of determining whether an object is located at least in front of or on a right or left side of the own vehicle;
perform a second determination step of determining whether a towed vehicle is located behind the own vehicle, the towed vehicle being coupled with the own vehicle, the towed vehicle having a front end and a rear end;
perform a third determination step of determining, in response to determination that (i) the object is located at least in front of or on the right or left side of the own vehicle and (ii) the towed vehicle is located behind the own vehicle, whether the rearward side object is a ghost due to the object determined by the first determination step and the towed vehicle determined by the second determination step based on a positional relationship between the object determined by the first determination step and the towed vehicle determined by the second determination step; and
establish a hard-to-detect area defined as an area in which detection by the radar-wave transceiver is hard, wherein:
the third determination step is configured to cause the rearward side object to be more likely to be determined as a ghost in a first case where the rearward side object is located in the hard-to-detect area as compared with a second case where the rearward side object is located outside the hard-to-detect area.

16. A surroundings monitoring method of recognizing, based on detection information acquired from a radio-wave transceiver, a rearward side object located behind and to a right or left side of an own vehicle, the radio-wave transceiver having a detection range located behind and to the right or left side of the own vehicle, the surroundings monitoring method comprising:
performing a first determination step of determining whether an object is located at least in front of or on a right or left side of the own vehicle;
performing a second determination step of determining whether a towed vehicle is located behind the own vehicle, the towed vehicle being coupled with the own vehicle, the towed vehicle having a front end and a rear end;
performing a third determination step of determining, in response to determination that (i) the object is located at least in front of or on the right or left side of the own vehicle and (ii) the towed vehicle is located behind the own vehicle, whether the rearward side object is a ghost due to the object determined by the first determination step and the towed vehicle determined by the second determination step based on a positional relationship between the object determined by the first determination step and the towed vehicle determined by the second determination step; and
establishing an object searching area located at least in front of or on the right or left side of the own vehicle in accordance with:
(i) a position of the radio-wave transceiver;
(ii) at least one of a position of each of left and right edges of the front end of the towed vehicle and a position of each of left and right edges of the rear end of the towed vehicle; and
(iii) an angle of the towed vehicle tilted to a traveling direction of the own vehicle, wherein:
the first determination step determines whether an object is located in the searching area established by the searching area establishing unit.

17. A surroundings monitoring method of recognizing, based on detection information acquired from a radio-wave transceiver, a rearward side object located behind and to a right or left side of an own vehicle, the radio-wave transceiver having a detection range located behind and to the right or left side of the own vehicle, the surroundings monitoring method comprising:
performing a first determination step of determining whether an object is located at least in front of or on a right or left side of the own vehicle;
performing a second determination step of determining whether a towed vehicle is located behind the own vehicle, the towed vehicle being coupled with the own vehicle, the towed vehicle having a front end and a rear end;
performing a third determination step of determining, in response to determination that (i) the object is located at least in front of or on the right or left side of the own vehicle and (ii) the towed vehicle is located behind the own vehicle, whether the rearward side object is a ghost due to the object determined by the first determination step and the towed vehicle determined by the second determination step based on a positional relationship between the object determined by the first determination step and the towed vehicle determined by the second determination step; and
establishing a hard-to-detect area defined as an area in which detection by the radar-wave transceiver is hard, wherein:
the third determination step causes the rearward side object to be more likely to be determined as a ghost in a first case where the rearward side object is located in the hard-to-detect area as compared with a second case where the rearward side object is located outside the hard-to-detect area.
